(19) United States
(12) Patent Application Publication
(10) Pub. No.: US 2014/0360318 A1
(43) Pub. Date: Dec. 11, 2014

(54) HIGH SPEED LUGNUT SOCKET

(71) Applicant: Brian James Cutler, Rowland Heights, CA (US)

(72) Inventor: Brian James Cutler, Rowland Heights, CA (US)

(21) Appl. No.: 14/300,589

(22) Filed: Jun. 10, 2014

Related U.S. Application Data
(60) Provisional application No. 61/833,079, filed on Jun. 10, 2013.

(51) Int. Cl. B25B 13/06; B25B 23/00

(52) U.S. Cl. CPC B25B 13/06; B25B 23/0057; B25B 23/0035
USPC 81/124.1; 81/121.1

(57) ABSTRACT

A socket for driving a lug nut. The socket may include a tapered external surface which eliminates shoulders which might otherwise exist at the external surface of the socket. The tapered external surface may be formed as a sleeve. In a second implementation, the sleeve may both provide the tapered external surface and may also cover one end of the socket to increase the overall diameter and hence grippability of the socket. The socket may be fabricated from steel, while either of the sleeves may be fabricated from a lighter material such as aluminum or an alloy thereof. The socket may have a chamfer at the internal termination of the wrench surface of the socket to better seat lug nuts having a correspondingly tapered configuration.

### CROSS-REFERENCE TO RELATED APPLICATION

This application claims the benefit of U.S. Provisional Application No. 61/833,079, filed Jun. 10, 2013.

### FIELD OF THE INVENTION

The present invention relates to tools, and more particularly to a socket wrench for expeditiously tightening and loosening lug nuts.

### BACKGROUND OF THE INVENTION

In racing, saving even small amounts of time in repairs and other operations necessary to keep a race car operable are of paramount importance. One area that has received attention is that of tire changes. Tires wear fast under race conditions, and must be periodically changed. Each tire change adds to the amount of time that a race car is out of action.

Improved tools for expeditiously changing tires have been proposed. However, in some prior art socket designs, the outer surface of the socket has two discrete diameters, with a sharp, discrete shoulder being defined at the transition of one diameter to the other diameter. Due to haste in trying to save time when changing tires, it has been experienced that the socket may catch on an environmental object, thereby taking longer to maneuver into place. It would be desirable to overcome this source of interference with orderly installation of the lug nut socket on lug nuts.

Also, a discrete shoulder may be formed inside the socket at the juncture of that portion of the socket chamber surrounding the lug nut and the remaining length of the socket. The remaining length is typically employed to house a spring which imposes spring force against the lug nut as the socket is being installed thereover. A rounded or tapered surface of the lug nut fails to seat quickly and securely when contacting this second discrete shoulder.

The above two situations present problems to existing lug nut sockets for racing.

### SUMMARY OF THE INVENTION

The present invention further improves on known tools by providing a lug nut socket better adapted to its purpose as that relates to saving time. The novel tool includes a supplementary sleeve which may be placed on the socket for streamlining the outer surface of the socket. This sleeve adapts prior art designs which bear a discrete shoulder to present a gradual tapering surface which makes transition between parts of the socket of different overall diameters. This tapering surface eliminates the discrete shoulder.

Providing the sleeve confers several improvements to the current situation. First, taper of the external surface eliminates the objectionable discrete shoulder at the exterior of the socket. Secondly, fabricating the sleeve from a relatively light material such as aluminum or an aluminum alloy reduces the total weight which would result from merely incorporating the taper, but forming the lug nut monolithically from steel. Further, the sleeve adds to the overall diameter of the lug nut, thereby making the lug nut easier to grasp by finger. The latter characteristic may be exploited to expedite locating the lug nut on its associated wheel under condition of high speed tire changes. The sleeve may reinforce the socket, possibly tending to contain shards should the socket disintegrate during use.

Also, a chamfer surface inside the socket may be provided to eliminate the internal discrete shoulder and to provide a better seating surface for seating a lug nut being engaged by the lug nut socket.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a perspective view of a lug nut socket and a supplementary sleeve;

FIG. 2 is a perspective view of a lug nut socket and a second type of supplementary sleeve;

FIG. 3 is a perspective view of the lug nut socket of FIGS. 1 and 2, with the sleeves and an internal spring removed.

FIG. 4 is a side cross section of the socket of FIG. 3, but with the supplementary sleeve of FIG. 1 included.

FIG. 5 is an end view of the socket of FIG. 3, shown partially in cross section.

FIG. 6 is a cross sectional view of a prior art lug nut socket.

### DETAILED DESCRIPTION

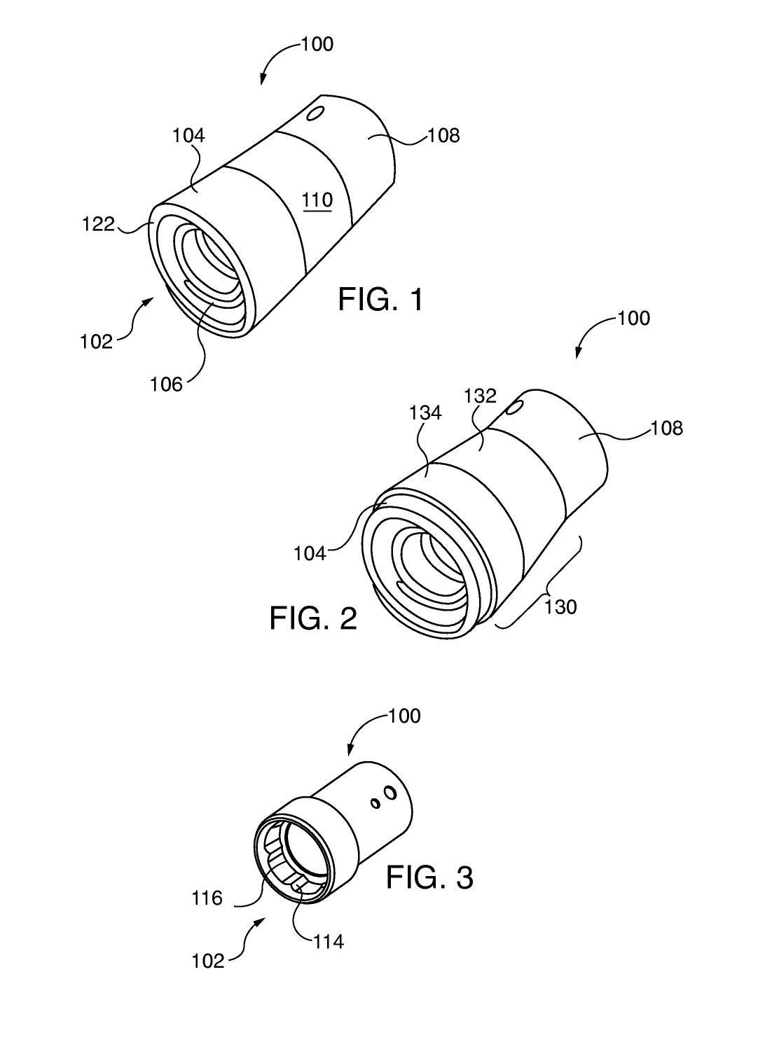

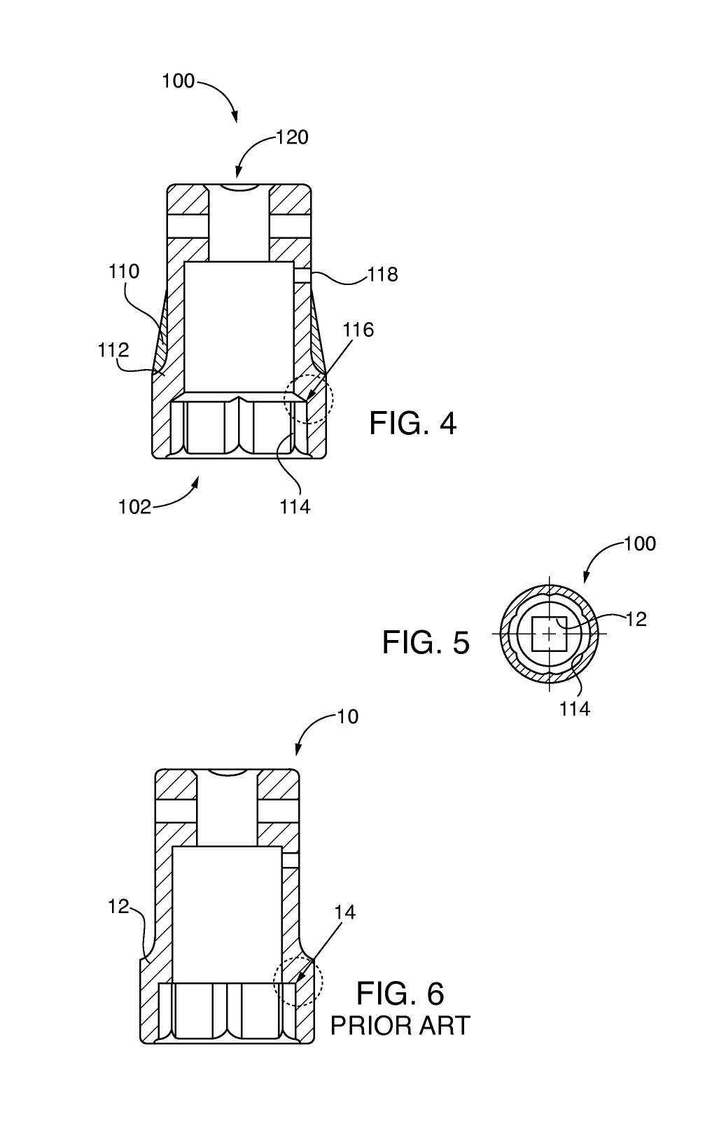

Referring first to FIGS. 1 and 4, according to at least one aspect of the invention, a fully assembled socket 100 is shown. The socket 100 comprises a socket chamber 102 having a wall 104 of a relatively large outside diameter, the socket chamber 102 shown containing a spring 106 which is intended to bear on a lug nut (not shown) during installation of the lug nut. The socket 100 also comprises an extension section 108 which houses the spring 106 when the lug nut is fully engaged by the socket 100. As seen in FIG. 1, the extension section 108 has a relatively small diameter compared to the diameter of the socket chamber 102.

As seen in FIG. 3, the socket chamber 102 bears a wrench surface 114 for engaging and helically rotating lug nuts (not shown). As utilized herein, the term “wrench surface” encompasses all of the facets or subsidiary sections of the internal surface of the socket chamber 102, and not only one internally projecting tooth or other portion of the full wrench surface. A chamfer 116 may be seen just above that point at which the wrench surface 114 terminates inside the socket 100.

It should be noted at this point that orientational terms such as above refer to the subject drawing as viewed by an observer. The drawing figures depict their subject matter in orientations of normal use, which could obviously change with changes in orientation and position of the socket 100. Therefore, orientational terms must be understood to provide semantic basis for purposes of description, and do not limit the invention or its component parts in any particular way.

The nature and function of the chamfer 116 may be better appreciated by comparing the chamfer 116 of the socket 100 with the corresponding location 14 in the prior art socket 10.

A sleeve 110 is shown placed on the socket 100 so as to abut a relatively sharp discrete shoulder 112 (best seen in FIG. 4 and seen as a discrete shoulder 12 in a prior art socket 10 shown in FIG. 6). Best seen in FIG. 4, the sleeve 110 provides a tapered outer surface which makes gradual transition between the relatively great diameter of the wall 104 and the wall of the relatively small diameter of the extension section 108.

FIG. 4 also shows a hole 118 for seating a tang (not specifically shown) of a free end of the spring 106 to retain the spring 106 in the socket 110, and an opening 120 for receiving a drive such as a square drive (not shown) of a pneumatic driver or gun for example.

FIG. 2 shows the socket 100 used with a sleeve 130. The sleeve 130 differs from the sleeve 110 in that the sleeve 130 has a tapered section 132 and a relatively large section 134 which covers the wall 104 of the socket 100. The sleeves 110 and 130 both eliminate the discrete shoulder 112 seen in FIG. 4. The sleeve 130 also increases the overall diameter of the socket 100 at the wall 104 to promote better grip and maneuverability.

The spring 106 may be provided in different lengths (this option is not shown). The different lengths may enable a lug nut to be flush with the outer edge 122 of the socket 100 (see FIG. 1) when the lug nut is fully received within the socket chamber 102, or alternatively to be received within the socket chamber 102 such that a short section of the wrench surface 114 is revealed with the lug nut fully received. The springs could be provided as a set of three springs each having an overall uncompressed length within one sixteenth of an inch of the next size of spring for example. The springs including the spring 106 may be close wound and flat ground on that end which contacts the lug nut.

The socket 100 is fabricated from a sturdy material such as steel. The sleeves 110, 130 may be fabricated from a lighter material, such as being fabricated substantially from aluminum. As employed herein, fabricated substantially from aluminum encompasses alloys wherein aluminum is the predominant metallurgical component.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A socket for driving lug nuts, comprising a socket chamber bearing an internal wrench surface, and an outer surface devoid of discrete shoulders.

2. The socket of claim 1, wherein the socket chamber has a first cylindrical outer surface and the socket comprises an extension having a second cylindrical outer surface which is of a diameter less than that of the first cylindrical outer surface, the socket further comprising a sleeve adapted to make a tapered transition between the first cylindrical outer surface and the second cylindrical outer surface.

4. The socket of claim 2, wherein the socket is fabricated from steel, and the sleeve is fabricated from aluminum.

5. The socket of claim 2, wherein the sleeve both covers the first cylindrical outer surface and also makes the tapered transition to the second cylindrical outer surface from that portion of the sleeve covering the first cylindrical outer surface.

6. The socket of claim 1, further comprising a chamfer formed in the socket chamber.

7. The socket of claim 1, further comprising a spring.

8. the socket of claim 7, further comprising a set of springs of different lengths.
